(19) United States
(12) Patent Application Publication
(10) Pub. No.: US 2013/0020961 A1
(43) Pub. Date: Jan. 24, 2013

(54) AUTOMATIC LOAD DISCRIMINATION CIRCUIT FOR REMOTE CONTROL RECEIVING CONTROLLER OF LAMP

(71) Applicant: Minghui LIN, Zhongshan (CN)

(72) Inventor: Minghui LIN, Zhongshan (CN)

(73) Assignee: WEIXING ELECTRONICS (ZHONGSHAN) CO., LTD., Zhongshan (CN)

(21) Appl. No.: 13/555,218

(22) Filed: Jul. 23, 2012

(30) Foreign Application Priority Data
Jul. 22, 2011 (CN) 201120260278.4

(51) Int. Cl. H05B 39/09

(52) U.S. Cl. 315/224

(57) ABSTRACT

An automatic discrimination circuit of load for a remote control receiving controller of a lamp, including: a switch control circuit for controlling a lamp load to be ducted with a power supply; a load type sampling circuit for sampling voltage signals at two ends of the lamp load; a remote control receiving control chip of the lamp for inputting a PWM dimming signal sequence into the switch control circuit and then comparing the PWM dimming signal sequence with a voltage waveform sequence at two ends of the lamp load sampled by the load type sampling circuit for determining the type of the lamp load; a wireless receiving module connected with the remote control receiving control chip for receiving a remote control command of an external remote controller; and an external memory chip connected with the remote control receiving control chip for storing load control mode digital information.

### CROSS-REFERENCE TO RELATED APPLICATIONS

Pursuant to 35 U.S.C. §119 and the Paris Convention Treaty, this application claims the benefit of Chinese Patent Application No. 201120260278.4 filed Jul. 22, 2011, the contents of which, including any intervening amendments thereto, are incorporated herein by reference. Inquiries from the public to applicants or assignees concerning this document and the documents incorporated by reference should be directed to: Matthias Scholl P.C., Dr. Matthias Scholl Esq., 14781 Memorial Dr., Suite 1319, Houston, Tex. 77079.

### BACKGROUND OF THE INVENTION

1. Field of the Invention

The invention relates to an automatic discrimination circuit of a load for a remote control receiving controller of a lamp.

2. Description of the Related Art

Conventional remote control receiving controllers of lamps are different for different load types, that is, when the load is an energy-saving lamp or an incandescent lamp, the adopted remote control receiving controller is different.

When the load is an incandescent lamp, the remote control receiving controller can execute the operations of lamp turning-on/turning-off/dimming; when the load is an energy-saving lamp, the remote control receiving controller only can execute the operations of lamp turning-on/turning-off, without the dimming operation. For a remote control receiving controller of an incandescent lamp, when an energy-saving lamp instead of an incandescent lamp is utilized by a user by mistake, it may cause the energy-saving lamp to flicker, and even the remote control receiving controller may be damaged, thereby bringing inconvenience and waste.

### SUMMARY OF THE INVENTION

In view of the above-described problems, it is one objective of the invention to provide an automatic discrimination circuit of load for a remote control receiving controller of a lamp that has good compatibility and can be connected with different types of lamp loads.

To achieve the above objective, in accordance with one embodiment of the invention, there is provided an automatic discrimination circuit of load for a remote control receiving controller of a lamp, comprising: a switch control circuit for controlling a lamp load to be ducted with a power supply; a load type sampling circuit for sampling voltage signals at two ends of the lamp load; a remote control receiving control chip of the lamp for inputting a PWM dimming signal sequence into the switch control circuit and then comparing the PWM dimming signal sequence with a voltage waveform sequence at two ends of the lamp load sampled by the load type sampling circuit for determining the type of the lamp load; a wireless receiving module connected with the remote control receiving control chip of the lamp for receiving a remote control command of an external remote controller; and an external memory chip connected with the remote control receiving control chip of the lamp for storing load control mode digital information.

In a class of this embodiment, the switch control circuit comprises a thyristor; one pole of the thyristor is connected with one end of the lamp load, the other pole of the thyristor is grounded, the other end of the lamp load is connected with a live wire of the power supply, and a gate pole control end of the thyristor is connected with the remote control receiving control chip of the lamp.

In a class of this embodiment, the switch control circuit further comprises a resistor, and the gate pole control end of the thyristor is connected with a PWM dimming signal output end of the remote control receiving control chip of the lamp.

In a class of this embodiment, the thyristor is a bidirectional thyristor.

In a class of this embodiment, the load type sampling circuit comprises an optical coupler, an anode of a diode of the optical coupler is connected with one end of the lamp load, a cathode of the diode of the optical coupler is connected with the other end of the lamp load, and a collecting electrode of a triode of the optical coupler is connected with the remote control receiving control chip of the lamp.

In a class of this embodiment, the load type sampling circuit further comprises a diode used for protecting the optical coupler, a cathode of the diode is connected with the anode of the diode of the optical coupler, and an anode of the diode is connected with the cathode of the diode of the optical coupler.

In a class of this embodiment, the lamp load is an energy-saving lamp or an incandescent lamp.

In a class of this embodiment, the PWM dimming signal sequence is a PWM level signal sequence with pulse width decreasing or increasing.

Advantages of the invention are summarized below. The automatic discrimination circuit of load can be compatible with the energy-saving lamp or incandescent lamp load. When the energy-saving lamp or incandescent lamp load is utilized by a user by mistake, the normal work is not affected, and the phenomena of flickering of the energy-saving lamp and damage of the remote control receiving controller are avoided, thereby bringing great convenience for production and use.

### BRIEF DESCRIPTION OF THE INVENTION

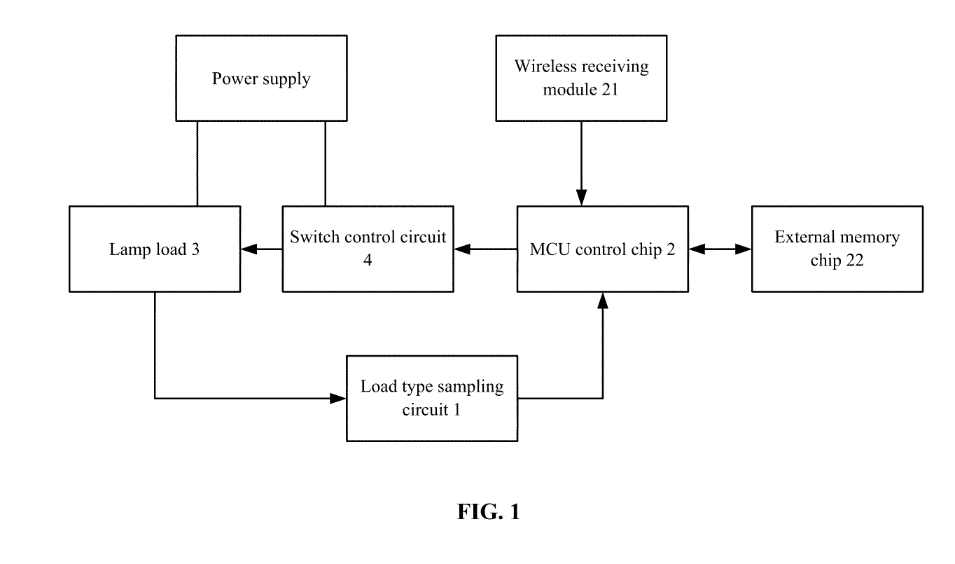

FIG. 1 is a structure diagram of an automatic discrimination circuit of load for a remote control receiving controller of a lamp in accordance with one embodiment of the invention; and

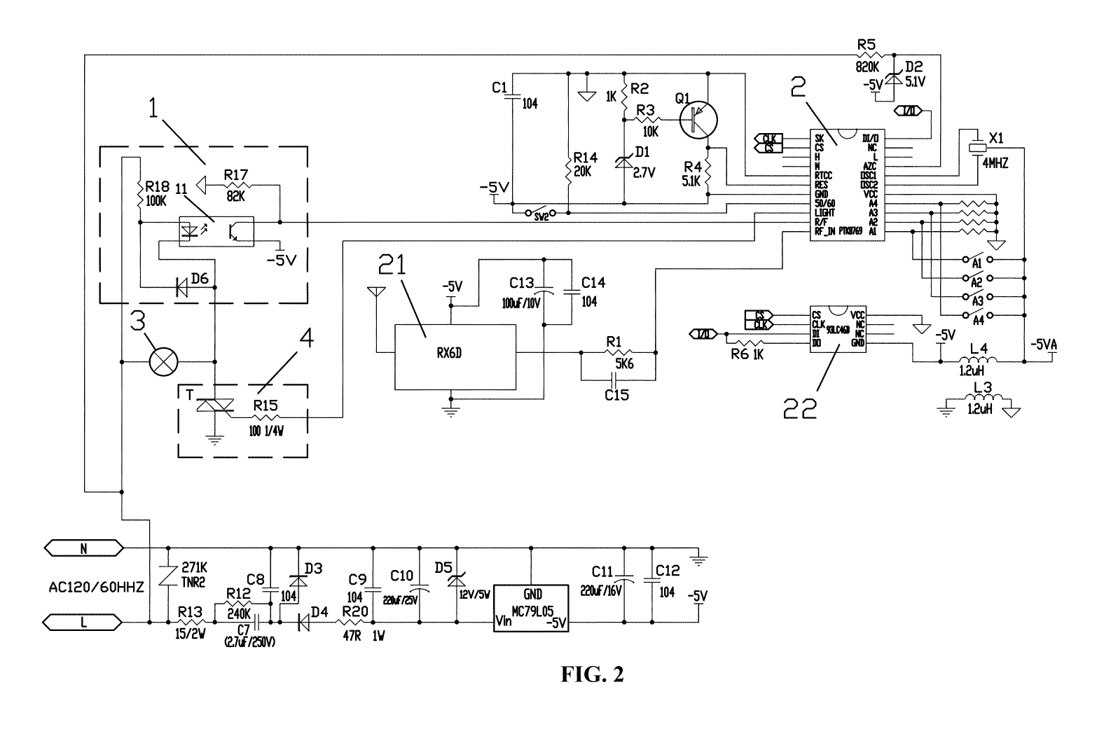

FIG. 2 is a circuit schematic diagram of an automatic discrimination circuit of load for a remote control receiving controller of a lamp in accordance with one embodiment of the invention.

### DETAILED DESCRIPTION OF THE INVENTION

For further illustrating the invention, experiments detailing an automatic discrimination circuit of load for a remote control receiving controller of a lamp are described below. It should be noted that the following examples are intended to describe and not to limit the invention.

As shown in FIG. 1, an automatic discrimination circuit of load for a remote control receiving controller of a lamp comprises a switch control circuit 4 for controlling a lamp load 3 to be ducted with a power supply, a load type sampling circuit 1 for sampling voltage signals at two ends of the lamp load 3, and a remote control receiving control chip 2 of the lamp for inputting a PWM dimming signal sequence into the switch control circuit 4 and then comparing the PWM dimming signal sequence with a voltage waveform sequence at two ends of the lamp load 3 sampled by the load type sampling circuit for determining the type of the lamp load 3, a wireless receiving module 21 connected with the remote control receiving control chip 2 of the lamp for receiving a remote control command of an external remote controller, and an external memory chip 22 also connected with the remote control receiving control chip 2 of the lamp for storing load control mode digital information.

As shown in FIG. 2, the remote control receiving control chip 2 of the lamp employs a microcontroller with model of PTK8769. A chip reset circuit comprising a voltage stabilizing tube D1, a triode Q1, a resistor R2, a resistor R3, a resistor R4, and a capacitor C1 is connected with the PTK8769 microcontroller. One end of the capacitor C1 is grounded, and the other end of the capacitor C1 is connected with −5V voltage; one end of the resistor R2 is grounded, and the other end of the resistor R2 is connected with one end of the resistor R3 via the cathode of the voltage stabilizing tube D1; the anode of the voltage stabilizing tube D1 is connected with −5V voltage, and the other end of the resistor R3 is connected with the base electrode of the triode Q1; the emitting electrode of the triode Q1 is grounded, the collecting electrode of the triode Q1 is connected with the remote control receiving control chip 2 of the lamp and one end of the resistor R4 respectively, and the other end of the resistor R4 is connected with −5V voltage; a chip operating frequency selective circuit comprising a switch SW2 and a resistor R14 is also connected on the remote control receiving control chip 2 of the lamp; one end of the switch SW2 is connected with −5V voltage, and the other end of the switch SW2 is connected with one end of the resistor R14 and the remote control receiving control chip 2 of the lamp respectively.

The external memory chip 22 employs a serial EEPROM memory chip with model of 93LC46B; the wireless receiving module 21 employs a wireless receiving board with model of RX6D for receiving external remote control signals through an antenna. The received external remote control signals are output to the remote control receiving control chip 2 of the lamp through a parallel resistance-capacitance circuit comprising an R1 and a C15, and then the remote control receiving control chip 2 of the lamp controls the lamp load 3 according to the remote control command.

The load type sampling circuit 1 comprises an optical coupler 11, a resistor R17, a resistor R18, and a diode D6. The anode of a diode of the optical coupler 11 is connected with one end of the lamp load 3 through the resistor R18 and then connected into a live wire of the power supply, and the cathode of the diode of the optical coupler 11 is connected with the other end of the lamp load 3. The diode D6 is oppositely connected at two ends of the diode of the optical coupler 11 in parallel. The emitting electrode of a receiving tube of the optical coupler 11 is connected with −5V voltage. The collecting electrode of the receiving tube of the optical coupler 11 is connected with one end of the resistor R17 and the remote control receiving control chip 2 of the lamp respectively, and the other end of the resistor R17 is grounded.

The lamp load 3 can be an energy-saving lamp or an incandescent lamp. One end of the lamp load 3 is connected with a live wire of the power supply, and the other end of the lamp load 3 is connected with the ground through the thyristor T to form a circuit.

The working principle of the automatic discrimination circuit of load is as follows:

The waveforms at two ends of the lamp load are sampled via the load type sampling circuit 1 and then discriminated via the remote control receiving control chip 2 of the lamp, and then the remote control receiving control chip 2 of the lamp outputs a signal to control the change of the lamp load 3. Specifically, after the lamp load 3 is connected with the remote control receiving control chip 2 of the lamp, the power supply is primarily turned on, or a remote controller is used for remotely controlling the operation from turning-on to turning-off of the lamp load 3, the remote control receiving control chip 2 of the lamp will continue to output the PWM dimming signal sequence with variation in lamp brightness (100%, 96%, and 90%) in a short period of time, and the lamp load 3 will be lighted up via the three signals, so that the voltage waveform sequences corresponding to the three lamp brightness variations are shown at two ends of the lamp load 3. After the waveform sequences are sampled by the load type sampling circuit 1, three narrow pulse-width signals are obtained and transmitted to the remote control receiving control chip 2 of the lamp for discrimination. If the narrow pulse-width signal sequences are decreased in sequence according to the lamp brightness of 100%, 96%, and 90%, it indicates that the lamp load 3 is an incandescent lamp, and if not, the lamp load 3 is discriminated as an energy-saving lamp, then the remote control receiving control chip 2 of the lamp sends out the correct discriminated lamp control signal, and the automatic lamp load discrimination is completed at the moment.

The PWM dimming signal sequence also can be a signal sequence with increasing brightness of 90%, 96%, and 100%, if the narrow pulse-width signal sequences are increased in sequence according to the lamp brightness of 90%, 96%, and 100%, it also indicates that the lamp load 3 is an incandescent lamp, and if not, the lamp load 3 is discriminated as an energy-saving lamp.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An automatic load discrimination circuit for a remote control receiving controller of a lamp, the circuit comprising:
a) a switch control circuit for controlling a lamp load to be ducted with a power supply;
b) a load type sampling circuit for sampling voltage signals at two ends of the lamp load;
c) a remote control receiving control chip of the lamp for inputting a PWM dimming signal sequence into the switch control circuit and then comparing the PWM dimming signal sequence with a voltage waveform sequence at two ends of the lamp load sampled by the load type sampling circuit for determining the type of the lamp load;
d) a wireless receiving module connected with the remote control receiving control chip of the lamp for receiving a remote control command of an external remote controller; and
e) an external memory chip connected with the remote control receiving control chip of the lamp for storing load control mode digital information.

2. The circuit of claim 1, wherein
the switch control circuit comprises a thyristor;
one pole of the thyristor is connected with one end of the lamp load, the other pole of the thyristor is grounded, and the other end of the lamp load is connected with a live wire of the power supply; and
a gate pole control end of the thyristor is connected with the remote control receiving control chip of the lamp.

3. The circuit of claim 2, wherein the switch control circuit further comprises a resistor, and the gate pole control end of the thyristor is connected with a PWM dimming signal output end of the remote control receiving control chip of the lamp.

4. The circuit of claim 2, wherein the thyristor is a bidirectional thyristor.

5. The circuit of claim 3, wherein the thyristor is a bidirectional thyristor.

6. The circuit of claim 1, wherein
the load type sampling circuit comprises an optical coupler;
an anode of a diode of the optical coupler is connected with one end of the lamp load, and a cathode of the diode of the optical coupler is connected with the other end of the lamp load; and
a collecting electrode of a triode of the optical coupler is connected with the remote control receiving control chip of the lamp.

7. The circuit of claim 6, wherein
the load type sampling circuit further comprises a diode used for protecting the optical coupler; and
a cathode of the diode is connected with the anode of the diode of the optical coupler, and an anode of the diode is connected with the cathode of the diode of the optical coupler.

8. The circuit of claim 1, wherein the lamp load is an energy-saving lamp or an incandescent lamp.

9. The circuit of claim 1, wherein the PWM dimming signal sequence is a PWM level signal sequence with pulse width decreasing or increasing.
